(19) United States
(12) Patent Application Publication
(10) Pub. No.: US 2019/0027308 A1
(43) Pub. Date: Jan. 24, 2019

(54) Capacitor Onto Cooling Device Mounting System

(71) Applicant: Celem Passive Components LTD, Jerusalem (IL)

(72) Inventors: Benjamin Jakoubovitch, Jerusalem (IL); Anat Jakoubovitch, Jerusalem (IL)

(21) Appl. No.: 16/081,969

(22) PCT Filed: Mar. 26, 2017
(86) PCT No.: PCT/IL17/50372

§ 371 Date: Sep. 4, 2018

Related U.S. Application Data
(60) Provisional application No. 62/353,627, filed on Jun. 23, 2016.

(51) Int. Cl. H01G 2/08; H01G 2/10; H01G 2/02

(52) U.S. Cl. CPC H01G 2/08; H01G 2/02; H01G 2/106

(57) ABSTRACT

A capacitor—cooling bus mounting system in which a fixing element driven through a fluid coolant passageway in the capacitor into a compatible bore in the bus bar that is also a coolant fluid passageway outlet or inlet provides a continuous fluid pathway for flow of coolant fluid from the cooling bus to and through the capacitor.

### TECHNICAL FIELD

The current method and system relate to power capacitors and in particular to mounting of high frequency, high voltage power capacitors on cooling devices.

### BACKGROUND

High voltage alternating current (AC) power capacitors are designed to meet the mechanical, electrical, and performance requirements of high voltage high frequency AC electrical circuits. Such capacitors commonly used in electrical circuits carrying peak voltages of, for example, 1400Vₚₑₐₖ and electrical current of 3000 Aᵣₘₛ are prone to Ohmic, dielectric and inductive energy losses mainly in the form of heat. For example, in a common high and medium frequency (e.g., 1 kHz to 1 MHz) power capacitor each 500 kVAr reactive power can generate a loss of 500 to 1000 Watt in the form of heat.

The large amount of heat lost by most high voltage alternating current (AC) power capacitors sometimes limits the number of capacitors one can use in a high voltage alternating current (AC) circuit as well as the configuration in which the capacitors can be lined up. For example, certain configurations of mounting more than one capacitor to a buss such as, for example, in series, may bring one or more capacitors, e.g., the last in the series, to overheat.

Solutions currently practiced include running a coolant such as water through an individual capacitor or mounting capacitors on cooling busses that dissipate the heat via conduction.

However, employing the above and other commonly practiced solutions requires mounting of one or more capacitors on a cooling bus and then connecting the system to a cooling fluid supply. This procedure may be time and labor consuming.

A system that will support fast and simple mounting of a number of capacitors to a cooling bus and that will concurrently provide a cooling system for all mounted on the cooling bus capacitors will not only cut back on labor but also make heat dissipation from each and every capacitor more efficient removing any limitations to capacitor-bus mounting configurations.

### SUMMARY

The present disclosure seeks to provide an efficient capacitor-cooling bus bar mounting system that provides adding one or more capacitors to an electrical circuit, mechanical mounting thereof and completing a capacitor advection-conduction capacitor cooling system in a single step.

In accordance with an example there is thus provided a capacitor including one or more coolant fluid passageways having one or more coolant fluid outlet openings and/or inlet openings that when brought into congruence and mounted onto a cooling bus bar with corresponding coolant fluid outlet openings and/or inlet openings in one or more cooling bus bars completes a advection-conduction capacitor cooling system.

In accordance with another example there is thus provided a capacitor—cooling bus mounting system in which a fixing element driven through a through hole coolant fluid passageway in a capacitor into a compatible bore in the bus bar that is also a coolant fluid passageway outlet or inlet providing a continuous fluid pathway for flow of coolant fluid from the cooling bus to and through the capacitor.

In accordance with another example there is thus provided a capacitor—cooling bus mounting system in which a fixing element driven through a through hole coolant fluid passageway in a capacitor into a compatible bore in the bus bar brings the capacitor and cooling bus into contact and supports cooling the capacitor by conduction.

In accordance with yet another example the fixing element can include a head having one or more cutouts extending from a contact surface of the head with the capacitor. The cutouts support coolant fluid flowing from a main in the bus bar over and around a stem of the fixing element to bypass the head of the fixing element via the cutouts and flow into passageways in the capacitor.

### BRIEF DESCRIPTION OF THE DRAWINGS

The present method and system will be understood and appreciated more fully from the following detailed description, taken in conjunction with the drawings in which:

FIG. 1, is an exploded and perspective view simplified illustration of a capacitor-cooling bus assembly 100 in accordance with an example;

FIG. 2 is a perspective and section view simplified illustration of assembled capacitor-cooling bus assembly in accordance with another example;

FIG. 3 is a perspective view of fixing element of a capacitor-cooling device mounting system in accordance with another example; and

FIGS. 4A, 4B and 4C collectively referred to as FIG. 4, are cross section view simplified illustrations of capacitor-cooling device mounting system in accordance with yet another example.

### DETAILED DESCRIPTION

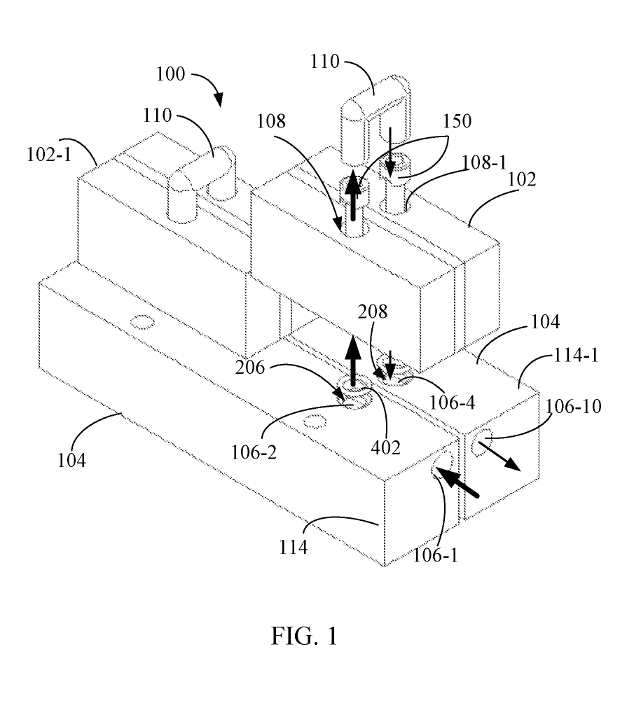

Reference is made to FIG. 1, which are exploded perspective view simplified illustrations of a capacitor-cooling bus assembly 100 in accordance with an example. FIG. 1 depicts alternating current (AC) power capacitors 102 and 102-1, a capacitor cooling bus 104, such as that described in U.S. Pat. Nos. 5,953,201 and 5,812,365, both assigned to the same assignee of the instant disclosure and included herein by reference and coolant fluid bridging conduits 110. This configuration supports concurrent mounting of electrically connected capacitors on a bus and connection to the bus cooling system.

Cooling bus 104 can include a high-low coolant fluid pressure heat removing system in one or more high pressure heat-removing bars 114 and low pressure heat-removing bars 114-1.

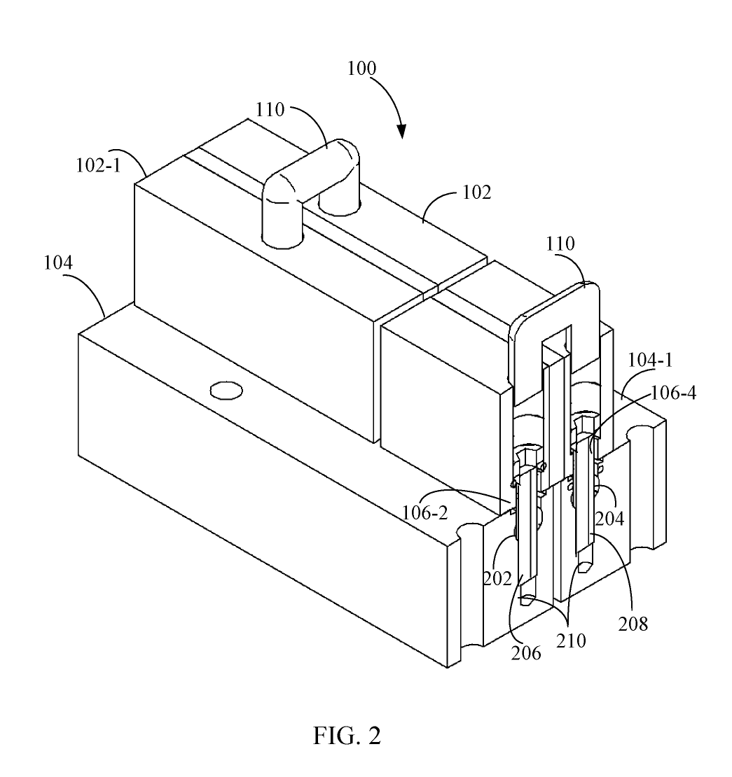

It is a particular feature of the present example that in cooling bus—capacitor mounting system 100 of FIG. 1 and as will be explained in greater detail below, mounting of power capacitor 102 on cooling bus 104 can be carried out with a fixing element 150 driven through a through hole 108 that functions as a coolant fluid passageway into a compatible bore 206/208 (FIG. 2), through a coolant fluid passageway outlet or inlet such as outlet 106-2 and inlet 106-4 concurrently mounting the capacitor to the cooling bus and providing a continuous fluid pathway for flow of coolant fluid from cooling bus 104 to and through capacitor 102. Thus, bores 206/208 and through hole 108 can function concurrently to mount capacitor 102 onto cooling bus 104 and to establish continuous fluid coolant passageways. Thus, cooling buss—capacitor mounting system 100 supports adding one or more capacitors to an electrical circuit, mechanical mounting thereof on a cooling bus and completing a capacitor advection-conduction capacitor cooling system in a single step.

Cooling bus 104 does not comprise any capacitor fixing element accommodating bores other than bores that include a coolant fluid passageway outlet or inlet such as outlet 106-2 and inlet 106-4. Alternatively, any capacitor fixing element accommodating bores in cooling bus 104 also include a coolant fluid passageway.

As shown in FIG. 1, one or more power capacitors can be mounted on cooling bus 104 in any desired configuration. Unoccupied coolant fluid passageway outlets or inlets (not shown), can be temporarily and reversibly plugged to prevent leakage of fluid coolant outside cooling bus 104.

Coolant fluids in cooling bus 104 can include water; oils such as, for example, mineral oil or silicone oils; suitable organic chemicals such as, for example, ethylene glycol or propylene glycol, refrigerants and others.

This configuration provides for the cooling of capacitor 102 not only by conduction of heat, through direct contact, from capacitor 102 to cooling bus 104, but also for concurrent cooling by heat advection, driving heat away from capacitor 102 via coolant fluid flowing therethrough thus creating a heat advection-conduction capacitor cooling system.

The capacitor heat advection system can include a high pressure coolant fluid portion, indicated in FIG. 1 by thick lined arrows and a low pressure coolant fluid portion indicated in FIG. 1 by thin lined arrows. For clarity of explanation and by example only, the direction of coolant flow is indicated for one capacitor 102 only. The capacitor heat advection system can operate by a high pressure coolant fluid flow into cooling bus 104 via high pressure coolant main inlet 106-1, exiting cooling bus 104 via high pressure coolant fluid passageway outlet 106-2, into and through capacitors 102 first through-hole 108, located in a first pole of capacitors 102 through coolant fluid bridging conduits 110 and into and through capacitor second through-hole 108-1 located in a second pole of capacitors 102 and into low pressure coolant fluid inlets 106-4, exiting cooling bus 104 via low pressure coolant fluid main outlet 106-10 thus forming the advection component of a heat advection-conduction capacitor cooling system.

O-rings 402 made of a suitable material can be placed between capacitor 102 and cooling bus 104 around bores 206/208 between cooling bus 104 bars 114 and capacitor 102.

Reference is now made to FIG. 2, which is a perspective and cross section view simplified illustration of assembled capacitor-cooling bus assembly 100 in accordance with another example. As shown in FIG. 2, cooling bus 104 can include a high pressure coolant fluid main 202 drilled through the body of cooling bus bar 104 and a low pressure coolant fluid main 204 drilled through the body of cooling bus bar 104-1.

It is a particular feature of the present example that coolant fluid mains 202/204 of cooling bus 104, do not communicate with each other and the coolant fluid passageway is only complete when one or more capacitors are mounted on the cooling bus. Hence, the configuration of cooling bus 104 as shown in the example of FIG. 2 can typically function in an advection/conduction capacitor cooling system in which coolant fluid mains 202/204 of cooling bus 104 communicate via fluid passages within mounted capacitors 102/102-1.

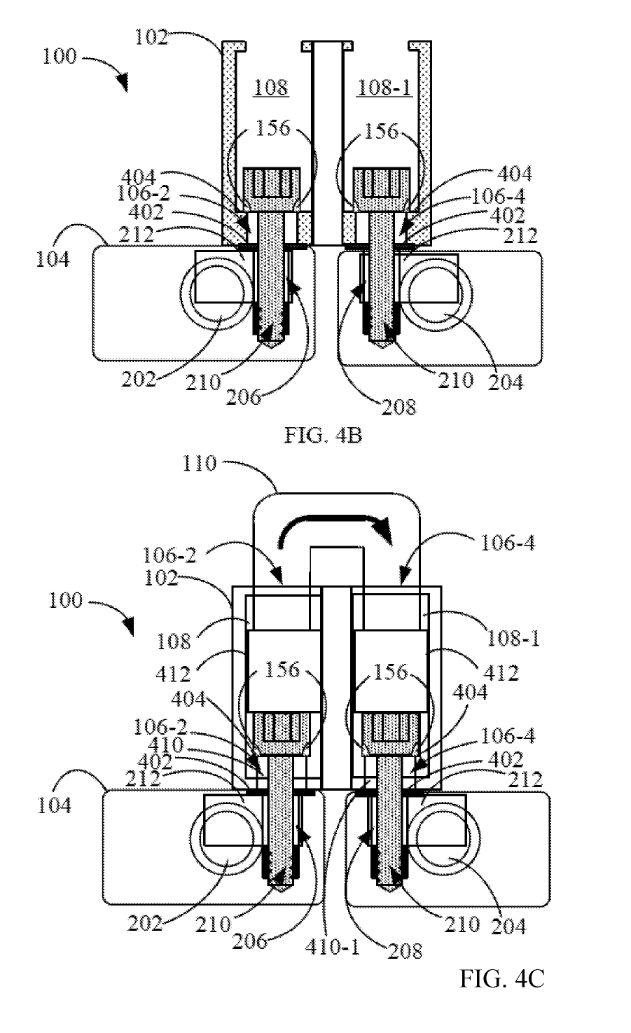

High pressure coolant fluid main 202 can communicate with one or more high pressure coolant fluid passageway outlets 106-2 via a bore 206 in cooling bus bar 104. Low pressure coolant main 204 communicates with one or more low pressure coolant fluid inlets 106-4 via a bore 208 in cooling bus bar 104-1. As seen in FIG. 2, both capacitors 102 and 102-1 can share both low and/or high pressure mains or each be individually supplied by or drained into a high or low pressure main respectively. Bores 206/208 can communicate with coolant fluid mains 202/204 directly or via ducts 212 (FIGS. 4A-4C).

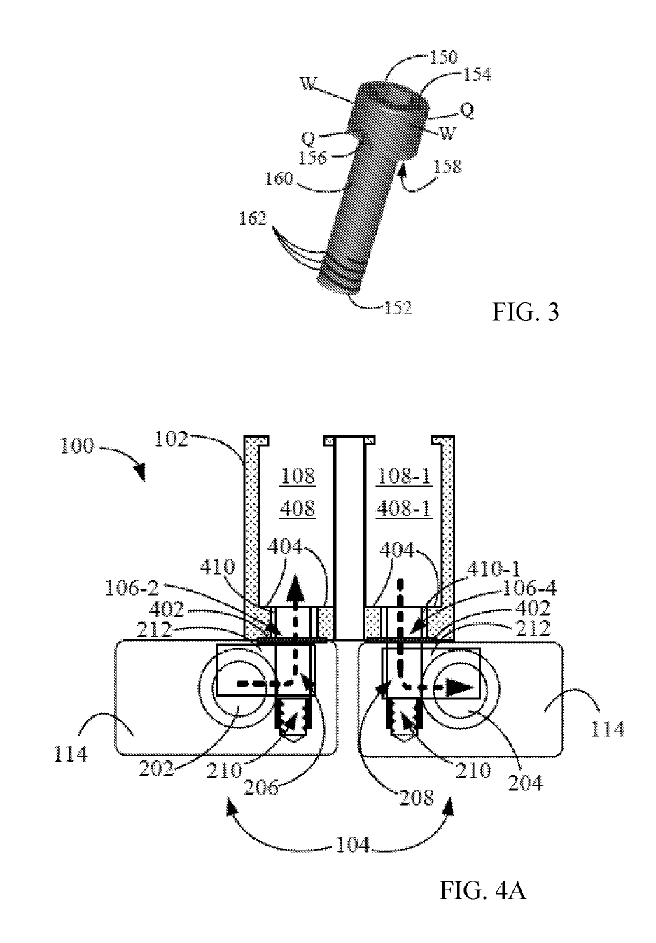

A locking receptacle 210 can be drilled through Bores 206/208 beyond mains 202/204 and bores 206/208 respectively meeting points and into the body of cooling busses 104 and 104-1 respectively to accommodate and lock a tip 152 (FIG. 3) of fixing element 150, thus concurrently, in a single step process mechanically mounting capacitor 102 onto cooling bus 104, adding one or more capacitor 102 to an electrical circuit and connecting coolant fluid passageways from cooling bus 104 to capacitor 102 and vice versa. The diameter of locking receptacle 210 can be smaller than the diameter of bores 206/208 to accommodate fixing element 150 with a smaller diameter than the diameter of bores 206/208. In the example of FIG. 4, locking receptacle 210 is threaded and locks fixing element 150 when it is screwed into position.

As will be explained in greater detail below, locking receptacle 210 can include a locking mechanism that locks fixing element 150 and thereby mounts capacitor 102 onto cooling bus 104 while concurrently creating a continuous fluid pathway from cooling bus 104 high pressure coolant main 202 through capacitor 102 through hole 108 and from through hole 108-1 through capacitor 102 and into low pressure coolant main 204.

The longitudinal axes of bores 206/208 can be at any suitable angle in respect to the longitudinal axes of mains 202/204. In the example of FIG. 2, the longitudinal axes of bores 206/208 are at a 90 degree angle in respect to the longitudinal axes of mains 202/204.

Reference is now made to FIG. 3, which is a perspective view of fixing element 150 of capacitor-cooling device mounting system in accordance with another example. Fixing element 150 can include a head 154 including one or more coolant fluid passageways extending from a fixing element 150—capacitor 102 contact surface 158 to allow passage of coolant fluid from cooling bus 104 to capacitor 102 once capacitor 102 is fixedly mounted onto cooling bus 104. In the example of FIG. 3, the coolant fluid passageway in head 154 is in a form of a cutout 156. Other coolant fluid passageways can include, for example, one or more holes drilled through fixing element 150 head 154 and/or a stem 160.

Stem 160 can be attached on a first end thereof to head 154 contact surface 158 and include on a second free end thereof a tip 152 including a locking mechanism 162. In the example shown in FIG. 3 locking mechanism 162 is a screw thread.

Cutouts 156 provide a bypass for coolant fluid to bypass head 154 of fixing element 150 by allowing a flow of coolant fluid therethrough. It is a particular feature of the present example that coolant fluid flow is maintained once capacitor coolant fluid through holes outlet openings and/or inlet openings are brought into congruence with corresponding coolant fluid outlet openings and/or inlet openings in one or more cooling bus bars and one or more capacitors 102 are mounted and fixing element 150 is locked in position. Thus, mounting capacitor 102 to bus bars 104 becomes a single step process both fixing capacitors 102 in position and connecting the coolant fluid passageways. As will be explained in greater detail below, the diameter of stem 160 can be smaller than the diameter of bores 206/208 to allow for coolant fluid to flow around stem 160. Additionally, the diameter of head 154 at the level Q-Q, i.e., the level of one or more cutouts 156, can be smaller than the diameter of bores 206/208 to provide a passageway for coolant fluid to flow from bore 206 to through hole 108 and/or from through hole 108-1 to bore 208 through one or more cutouts 156 with fixing element 150 locked into position.

Referring now to FIGS. 4A, 4B and 4C, collectively referred to as FIG. 4, which are cross section view simplified illustrations of capacitor-cooling device mounting system in accordance with yet another example. As shown in FIG. 4A, through holes 108/108-1 can have a wide portion 408/408-1 and a narrow portion 410/410-1 respectively and a lip 404 in a wall thereof connecting therebetween. Lip 404 can act as a seat for head 154 contact surface 158 when fixing element 150 is in a locked position (FIG. 4B).

A coolant fluid flow pathway, depicted in FIG. 4A by thick broken-line arrows of a coolant fluid from high pressure main 202 to capacitor 102 through hole 108 and/or from through hole 108-1 to low pressure main 204. In FIG. 4A capacitor 102 is attached to cooling bus 104 but not fixed thereto. O-rings 402 made of a suitable material can be placed between capacitor 102 and cooling bus 104 around bores 206/208 between cooling bus 104 bars 114 and capacitor 102.

FIG. 4B illustrates head 154 contact surface 158 urged against lip 404 and fixing element 150 tip 152 locked into position inside locking receptacle 210, fixing capacitor 102 to cooling bus 104 and supporting a continuous fluid pathway from cooling bus 104 main 202 into capacitor through hole 108 narrow portion 410, through cutouts 156 into capacitor through hole 108 wide portion 408.

FIG. 4C depicts a full capacitor-cooling device mounting system, in which bridging conduit 110 is connected via an adaptor 412 on a first end to capacitor through hole 108 wide portion 408 and on a second end to capacitor through hole 108-1 wide portion 408-1. This completes the coolant fluid flow cycle from capacitor through hole 108 wide portion 408, through adaptor 412 and bridging conduit 110 in a direction depicted by a thick-lined arrow and into capacitor through hole 108-1 wide portion 408-1, through cutouts 156 into through hole 108-1 narrow portion 410-1 and into low pressure coolant fluid main 204.

It will be appreciated by persons skilled in the art that the present systems methods are not limited to what has been particularly shown and described hereinabove. Rather, the scope of the method and system includes both combinations and sub-combinations of various features described hereinabove as well as modifications and variations thereof which would occur to a person skilled in the art upon reading the foregoing description and which are not in the prior art.

What we claim is:

1. Capacitor to cooling bus mounting system comprising
at least one through hole in the capacitor that communicates with at least one coolant fluid passageway in a bus bar; and
a fixing element driven through the through hole into and locked inside a bore and supports a continuous fluid pathway from the bus bar into the capacitor.

2. The system according to claim 1, wherein the fixing element comprises a head having a fixing element-capacitor contact surface and wherein at least one cutout extending from the contact surface provides a bypass for coolant fluid to bypass the head when the fixing element is locked in position.

3. The system according to claim 1, wherein the fixing element also comprises a stem attached to a fixing element-capacitor contact surface and having a fixing element locking mechanism at a free end thereof.

4. The system according to claim 1, wherein the fixing element includes a head and a stem at least one of which having at least one fluid coolant passageway.

5. The system according to claim 1, wherein the at least one passageway comprises at least one cutout extending from a contact surface of a head with the capacitor, where cutouts support coolant fluid flowing from a main in the bus bar over and around a stem of the fixing element, bypass the head through the cutouts and flow into passageways in the capacitor.

6. The system according to claim 1, wherein the fixing element driven through the through hole and locked inside the bore concurrently mounts the capacitor to the cooling bus and creates a continuous fluid passageway from the cooling bus through the capacitor through hole.

7. The system according to claim 1, wherein driving the fixing element through the capacitor through hole and locking it into position in the bus bar is a single step process adding one or more capacitors to an electrical circuit, mechanical mounting thereof to a cooling bus and completing a capacitor advection-conduction capacitor cooling system.

8. The system according to claim 1, wherein bore and through hole function concurrently to mount the capacitor onto the cooling bus and to establish a continuous coolant fluid passageway.

9. A single step capacitor onto cooling bus mounting system comprising
at least one cooling bus bar having at least one coolant fluid pathway;
at least one capacitor having at least one coolant fluid through hole; and
at least one fixing element; and
wherein mounting the capacitor onto the cooling bus with the fixing element mechanically fixes the capacitor in position on the cooling bus, adds at least one capacitor to an electrical circuit and connects a coolant fluid passageway comprising at least the cooling bus bar coolant fluid pathway and the capacitor through hole.

10. Advection-conduction capacitor cooling system comprising:
at least one cooling bus having at least one cooling bar including at least one coolant fluid passageway;
at least one capacitor having at least one coolant fluid passageway; and
at least one fixing element; and
wherein mounting the capacitor onto a cooling bus with the fixing element brings the capacitor and cooling bus into contact and supports cooling the capacitor by conduction and also creates a continuous coolant fluid passageway through the cooling bus bar and the capacitor supporting cooling the capacitor by advection.

11. The system according to claim 10, wherein the coolant fluid passageways in the cooling bus do not communicate with each other and the fluid coolant passageway is only complete when at least one capacitor is mounted on the cooling bus.

12. The system according to claim 1, wherein a coolant fluid is selected from a group of coolant fluids including water; oils and suitable organic chemicals.

13. The system according to claim 1, wherein the fixing element is locked into position by a threaded screw mechanism.

14. A method for attaching a capacitor to a cooling bus, comprising:
bringing at least one through hole opening in the capacitor in congruence with at least one cooling fluid passageway opening in the cooling bus;
driving a fixing element through the capacitor through hole and into the coolant fluid passageway opening; and
locking the fixing element inside the coolant fluid passageway in the bus, concurrently
mounting the capacitor onto the cooling bus; and
completing a coolant fluid passageway from the cooling bus passageway opening through the capacitor through hole.

15. The method according to claim 14, wherein driving the fixing element through the capacitor through hole and locking it into position in bus bar is a single step process comprising
adding one or more capacitors to an electrical circuit;
mechanically mounting at least one capacitor to a cooling bus; and
completing a capacitor advection-conduction capacitor cooling system.
